(19) United States
(12) Patent Application Publication
(10) Pub. No.: US 2021/0250987 A1
(43) Pub. Date: Aug. 12, 2021

(54) TIMER CONTROL METHOD, DEVICE, ELECTRONIC APPARATUS, AND COMPUTER READABLE STORAGE MEDIUM

(71) Applicant: Beijing Xiaomi Mobile Sofeware Co., Ltd., Beijing (CN)

(72) Inventors: Xiaowei JIANG, Beijing (CN); Ming ZHANG, Beijing (CN)

(73) Assignee: Beijing Xiaomi Mobile Sofeware Co., Ltd., Beijing (CN)

(21) Appl. No.: 17/251,625

(22) PCT Filed: Jun. 14, 2018
(86) PCT No.: PCT/CN2018/091358

§ 371 Date: Dec. 11, 2020

(51) Int. Cl. H04W 74/00; H04W 74/08; H04W 72/04; H04L 5/00

(52) U.S. Cl. CPC H04W 74/006; H04L 5/0098; H04W 72/0453; H04W 74/0833

(57) ABSTRACT

Aspect of the disclosure can provide a timer control method that can include receiving, at a first cell, a message of a physical downlink control channel (S1), and starting or restarting a bandwidth part inactivity timer for an activated downlink bandwidth part of the first cell, and starting or restarting a bandwidth part inactivity timer for an activated downlink bandwidth part of the second cell, if it is determined based on the message of the physical downlink control channel that a random access initiated at a second cell is successful (S2).

### RELATED APPLICATION(S)

The present application is a 35 U.S.C. 371 national stage application of PCT International Application No. PCT/CN2018/091358 filed on Jun. 14, 2018, the entire disclosure of which is incorporated herein by reference.

### TECHNICAL FIELD

The present application relates to the technical field of communication, incuding to a timer control method, a timer control device, an electronic apparatus, and a computer readable storage medium.

### BACKGROUND

In New Radio (NR) technology, it is possible to divide a carrier bandwidth into multiple Bandwidth Parts (BWPs), and to roll back an activated downlink BWP automatically to the default or initial functionality if it is inactive for a period of time. This is done by setting a BWP inactivity timer to record the time duration during which the activated downlink BWP is inactive.

Under the current protocols, when a user device initiates a random access at a service cell, it will stop the BWP inactivity timer for the activated downlink BWP of that cell, and start or restart the BWP inactivity timer for the activated downlink BWP of that cell, if a message of a physical downlink control channel (PDCCH) received at that cell indicates that the random access is successful.

However, the current considerations for starting or restarting the BWP inactivity timer are not comprehensive, and it is impossible to accurately start or restart the BWP inactivity timer with respect to the interaction scenarios between certain user devices and cells.

### SUMMARY

In view of above, embodiments of the present disclosure provide a timer control method, a timer control device, an electronic apparatus, and a computer readable storage medium.

According to a first aspect of the present disclosure, a timer control method is proposed, which is applicable to a user device. The timer control method can include receiving, at a first cell, a message of a physical downlink control channel sent by a base station. The method can further include starting or restarting a bandwidth part inactivity timer for an activated downlink bandwidth part of the first cell, and starting or restarting a bandwidth part inactivity timer for an activated downlink bandwidth part of the second cell, if it is determined based on the message of the physical downlink control channel that a random access initiated at a second cell to the base station is successfull. Optionally, the first cell and the second cell can be different cells. Also, the first cell and the second cell can be the same cell.

Optionally, the timer control method can also include determining whether the user device is configured with a bandwidth part inactivity timer, before the message of the physical downlink control channel sent by the base station is received at the first cell. In a case where the user device is configured with a bandwidth part inactivity timer, the bandwidth part inactivity timer for the activated downlink bandwidth part of the first cell can be started or restarted, and the bandwidth part inactivity timer for the activated downlink bandwidth part of the second cell can be started or restarted, if it is determined based on the message of the physical downlink control channel that a random access initiated at the second cell to the base station is successful.

Optionally, the timer control method can also include determining whether the first cell and the second cell are configured with a bandwidth part inactivity timer, before the message of the physical downlink control channel sent by the base station is received at the first cell. In a case where the first cell and the second cell are configured with a bandwidth part inactivity timer, the bandwidth part inactivity timer for the activated downlink bandwidth part of the first cell can be started or restarted, and the bandwidth part inactivity timer for the activated downlink bandwidth part of the second cell can be started or restarted, if it is determined based on the message of the physical downlink control channel that the random access initiated at the second cell to the base station is successful.

According to a second aspect of the present disclosure, a timer control device is proposed which is applicable to a user device. The timer control device can include a message receiver that is configured to receive at a first cell a message of a physical downlink control channel sent by a base station. The device can further include a timer controller that is configured to start or restart a bandwidth part inactivity timer for an activated downlink bandwidth part of the first cell, and to start or restart a bandwidth part inactivity timer for an activated downlink bandwidth part of the second cell, if it is determined based on the message of the physical downlink control channel that a random access initiated at the second cell to the base station is successful.

The first cell and the second cell can be different cells. Optionally, the first cell and the second cell can be the same cell.

Additionally, the timer control device also can also include a first determination module that is configured to determine whether the user device is configured with a bandwidth part inactivity timer, before the message receiver receives at the first cell the message of the physical downlink control channel sent by the base station. The timer controller can be configured to start or restart the bandwidth part inactivity timer for the activated downlink bandwidth part of the first cell, and to start or restart the bandwidth part inactivity timer for the activated downlink part of the second cell, if the user device is configured with a bandwidth part inactivity timer, and the random access initiated at the second cell to the base station is successful as determined based on the message of the physical downlink control channel.

The timer control device can also include a second determination module that is configured to determine whether the first cell and the second cell are configured with a bandwidth part inactivity timer, before the message receiver receives at the first cell the message of the physical downlink control channel sent by the base station. The timer controller can be configured to start or restart the bandwidth part inactivity timer for the activated downlink bandwidth part of the first cell, and to start or restart the bandwidth part inactivity timer for the activated downlink bandwidth part of the first cell, if the first cell and the second cell are configured with a bandwidth part inactivity timer, and the random access initiated at the second cell to the base station is successful as determined based on the message of the physical downlink control channel.

According to a third aspect of the present disclosure an electronic apparatus is proposed that can include a processor and a memory that is configured to store instructions executable by the processor. The processor is configured to perform the timer control method described in any of the above embodiments.

According to a fourth aspect of the present disclosure, a non-transitory computer readable storage medium is proposed, containing a computer program stored thereon, wherein the computer program is configured, when executed by a processor, to implement steps of the timer control method described in any of the above embodiments.

### BRIEF DESCRIPTION OF THE DRAWINGS

In order to illustrate more clearly the technical approach in the present application, a brief description is provided in the following of the drawings to be used in the description of exemplary embodiments. It is obvious that the drawings described below are only some embodiments of the present application, and that other embodiments may be obtained on the basis of these drawings.

FIG. 1 is a schematic flowchart showing a timer control method according to an embodiment of the present disclosure.

FIG. 2 is a schematic flowchart showing a timer control method according to another embodiment of the present disclosure.

FIG. 3 is a schematic flowchart showing a timer control method according to yet another embodiment of the present disclosure.

FIG. 4 is a schematic block diagram showing a timer control device according to an embodiment of the present disclosure.

FIG. 5 is a schematic block diagram showing a timer control device according to another embodiment of the present disclosure.

FIG. 6 is a schematic block diagram showing a timer control device according to yet another embodiment of the present disclosure.

FIG. 7 is a schematic block diagram showing an apparatus for controlling a timer according to an embodiment of the present disclosure.

### DETAILED DESCRIPTION OF THE EMBODIMENTS

In the following, a clear and complete description of the technical approach in exemplary embodiments of the present application is provided in conjunction with the drawings in embodiments of the present application. Obviously, the embodiments described herein are only some embodiments of the present application, but not all of them. Based on these embodiments in the present application, all the other embodiments obtained by an ordinary technician in the field fall within the protection scope of the present application.

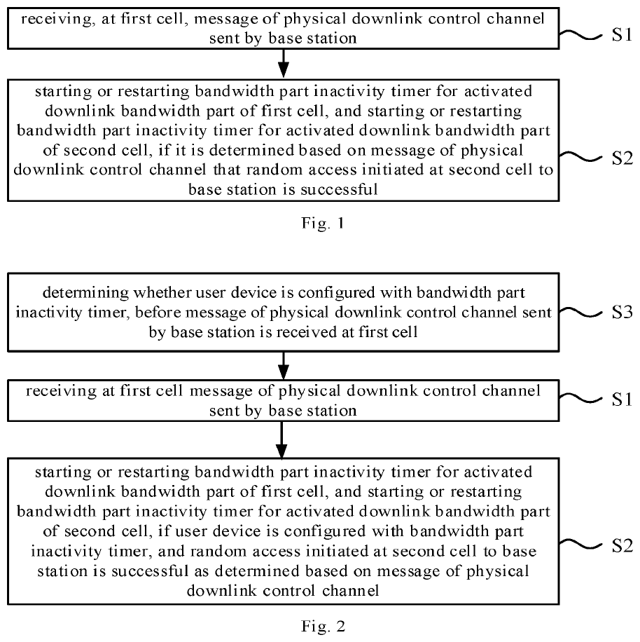

FIG. 1 is a schematic flowchart showing a timer control method according to an embodiment of the present disclosure. The timer control method shown in the present embodiment can be applicable to a user device, wherein the user device can be a mobile phone, a tablet computer, and the like, and the user device can communicate with a base station.

As shown in FIG. 1, the timer control method can include the following steps.

In step S1, a message of a physical downlink control channel sent by a base station is received at a first cell. In one embodiment, the user device can initiate a random access to a base station, for example by sending a preamble of the random access to the base station, and receive a message of a physical downlink control channel sent by the base station. Thus, it can be determined, based on the received message of the physical downlink control channel, whether the initiated random access is successful. The above message of the physical downlink control channel can be a message indicating that the base station assigns a cellular radio network temporary identity (C-RNTI) to the user device.

In step S2, if it is determined based on the message of the physical downlink control channel that the random access initiated at the second cell to the base station is successful, the bandwidth part inactivity timer for the activated downlink bandwidth part of the first cell is started or restarted, and the bandwidth part inactivity timer for the activated downlink bandwidth part of the second cell is started or restarted.

According to an embodiment, in a case where it is determined based on the message of the physical downlink control channel that the random access initiated at the second cell to the base station is successful, the bandwidth part inactivity timer for the activated downlink bandwidth part of the first cell can be started if such bandwidth part inactivity timer has never been started, and the bandwidth part inactivity timer for the activated downlink bandwidth part of the first cell can be restarted if such bandwidth part inactivity timer is running or has been stopped. The same process applies to the second cell, and repeated descriptions will not be provided herein.

The following embodiments focus on a case, where it is determined based on the message of the physical downlink control channel that the random access initiated at the second cell to the base station is successful, and the bandwidth part inactivity timer for the activated downlink bandwidth of the first cell has been stopped, for the purpose of illustrating schematically the technical approach of the present disclosure.

In an embodiment, when a user device initiates a random access at a certain cell, it will stop the bandwidth part inactivity timer for the activated downlink bandwidth part of such cell. However, for a certain type of cell, such as a secondary cell, i.e., a service cell except for the primary cell and the primary-secondary cell, the user device, after initiating a random access at such type of cell, needs to receive at another type of cell, such as a primary cell or a primary-secondary cell, a message of a physical downlink control channel sent by a base station, so as to determine whether the initiated random access is successful.

In this case, it is of the first cell (e.g., a secondary cell) where the user device initiates the random access, and it is of the second cell (e.g., a primary cell or a primary-secondary cell), which is different from the first cell, where the user device receives the message of the physical downlink control channel. While initiating the random access, the user device will not only stop the bandwidth part inactivity timer for the activated downlink bandwidth part of the first cell, but also will stop the bandwidth part inactivity timer for the activated downlink bandwidth part of the second cell.

In a case where it is determined based on the message of the physical is downlink control channel that the random access is successful, if only the the bandwith part inactivity timer for the activated downlink bandwidth part of the first cell is started or restarted, the bandwidth part inactivity timer for the activated downlink bandwidth part of the second cell will remain stopped. Thus, it is unable to record the time duration during which the activated downlink bandwidth part is inactive, rendering it impossible to roll back promptly to the default or initial functionality of such bandwidth part.

According to an embodiment of the present disclosure, not only the bandwidth part inactivity timer for the activated downlink bandwidth part of the first cell can be started or restarted, but also the bandwidth part inactivity timer for the activated downlink bandwidth part of the second cell can be started or restarted. In this way, the bandwidth part inactivity timers, which have been stopped, for the activated downlink bandwidth parts of the first cell and the second cell can be started or restarted. This allows keeping a record of the time duration during which the activated downlink bandwidth part of the first cell is inactive, and also of the time duration during which the activated downlink bandwidth part of the second cell is inactive. Thus, it is ensured that the functionality of the activated downlink bandwidth part of the first cell and the functionality of the activated downlink bandwidth part of the second cell can be rolled back respectively in a prompt way to the default or initial functionality of the respective bandwidth part.

Optionally, the first cell and the second cell can be different cells. Further, the first cell and the second cell can be the same cell.

According to the present disclosure, the embodiment shown in FIG. 1 may applicable to a case where the first cell and the second cell are different cells, and also to a case where the first cell and the second cell are the same cell. If the first cell and the second cell are the same cell, it is only required to start or restart the bandwidth part inactivity timer for the activitated downlink bandwidth part once for this same cell.

FIG. 2 is a schematic flowchart showing a timer control method according to is another embodiment of the present disclosure. As shown in FIG. 2, apart from those steps described with respect to the embodiment shown in FIG. 1, the timer control method also comprises the following step.

In step S3, it is determined whether the user device is configured with a bandwidth part inactivity timer, before the message of the physical downlink control channel sent by the base station is received at the first cell. In a case where the user device is configured with a bandwidth part inactivity timer, if it is determined based on the message of the physical downlink control channel that the random access initiated at the second cell to the base station is successful, the bandwidth part inactivity timer for the activated downlink bandwidth part of first cell is started or restarted, and the bandwidth part inactivity timer for the activated downlink bandwidth part of the second cell is started or restarted.

In an embodiment, the base station can configure a bandwidth part inactivity timer specifically for the user device, and the user device can determine whether it is configured with a bandwidth part inactivity timer before it receives at the first cell the message of the physical downlink control channel sent by the base station. If the user device is configured with a bandwidth part inactivity timer, it is required to roll the functionality of the activated downlink bandwidth part of all the cells served by the user device back to the default or initial functionality of such bandwidth part, when such activated downlink bandwidth part is inactive for a time duration that is longer than a preset time duration.

Thus, only when it is determined based on the message of the physical downlink control channel that the random access initiated at the second cell to the base station is successful, is it necessary to reactivate the bandwidth part inactivity timer for the activated downlink bandwidth part of the first cell, and to start or restart the bandwidth part inactivity timer for the activated downlink bandwidth part of the second cell, so as to ensure that the functionality of the activated downlink bandwidth part of the first cell and the functionality of the activated downlink bandwidth part of the second cell are rolled back respectively in a prompt way to the default or initial functionality of the respective bandwidth part.

It should be noted that, in view of the above embodiment shown in FIG. 2, when the user device establishes a communication connection with the base station, the base station can configure a bandwidth part inactivity timer for the user device, such as a bandwidth part inactivity timer configured specifically for such user device, then the base station can also indicate to the user device the association of the bandwidth part inactivity timer with the user device.

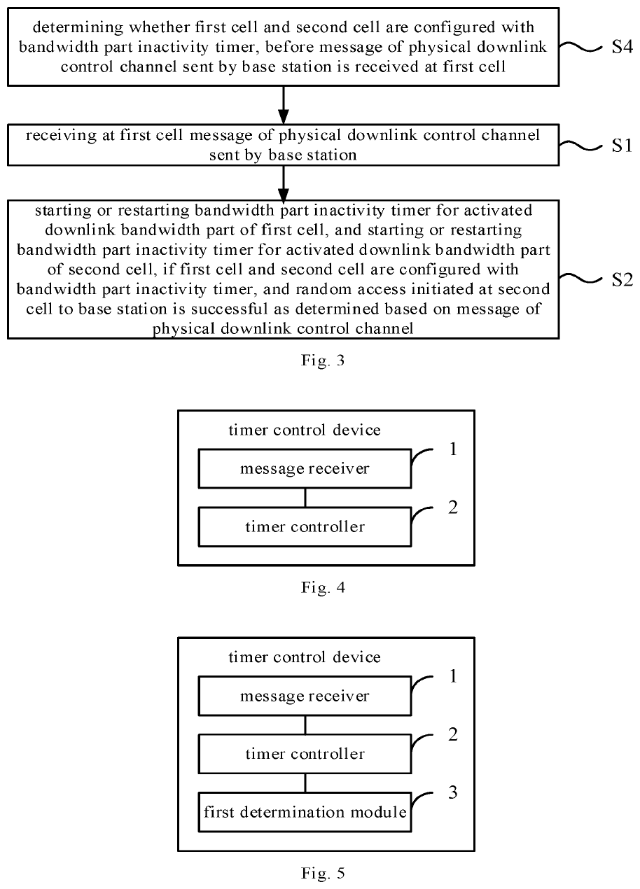

FIG. 3 is a schematic flowchart showing a timer control method according to yet another embodiment of the present disclosure. As shown in FIG. 3, apart from those steps described with respect to the embodiment shown in FIG. 1, the timer control method can also include the following step.

In step S4, it is determined whether the first cell and the second cell are configured with a bandwidth part inactivity timer, before the message of the physical downlink control channel sent by the base station is received at the first cell. In a case where the first cell and the second cell are configured with a bandwidth part inactivity timer, if it is determined based on the message of the physical downlink control channel that the random access initiated at the second cell to the base station is successful, the bandwidth part inactivity timer for the activated downlink bandwidth part of the first cell is started or restarted, and the bandwidth part inactivity timer for the activated downlink bandwidth part of the second cell is started or restarted.

In one embodiment, the base station can configure a bandwidth part inactivity timer for the cell, and the user device can determine whether the first and second cells are configured with a bandwidth part inactivity timer, before the message of the physical downlink control channel sent by the base station is received at the first cell. If the first and second cells are configured with a bandwidth part inactivity timer, it is required to roll the functionality of the activated downlink bandwidth part of the first cell and the second cell back to the default or initial functionality of the respective bandwidth part when such activated downlink bandwidth part is inactive for a time duration that is longer is than a preset time duration.

Thus, only when it is determined based on the message of the physical downlink control channel that the random access initiated at the second cell to the base station is successful, is it necessary to reactivate the bandwidth part inactivity timer for the activated downlink bandwidth part of the first cell, and to start or restart the bandwidth part inactivity timer for the activated downlink bandwidth part of the second cell, so as to ensure that the functionality of the activated downlink bandwidth part of the first cell and the functionality of the activated downlink bandwidth part of the second cell are rolled back respectively in a promptly to the default or initial functionality of the respective bandwidth part.

It should be noted that, in view of the above embodiment shown in FIG. 3, when the user device establishes a communication connection with the base station, the base station can configure a bandwidth part inactivity timer for the user device, such as a bandwidth partial inactivity timer configured specifically for the first cell, then the base station can also indicate to the user device the association of the bandwidth part inactivity timer with the first cell.

Corresponding to the aforementioned embodiments of a timer control method, the present disclosure also provides embodiments of a timer control device.

FIG. 4 is a schematic block diagram showing a timer control device according to an embodiment of the present disclosure. The timer control device shown in this embodiment can be applicable to a user device, wherein the user device can be a mobile phone, a tablet computer, and the like, and the user device can communicate with a base station.

As shown in FIG. 4, the timer control device can include a message receiver 1 that is configured to receive at a first cell a message of a physical downlink control channel sent by a base station. The device can further include a timer controller 2 that is configured to start or restart a bandwidth part inactivity timer for an activated downlink bandwidth part of the first cell, and to start or restart a bandwidth part inactivity timer for the activated downlink bandwidth part of the second cell, if it is determined based on the message of the physical downlink control channel that a random access initiated at the second cell to the base station is successful.

Optionally, the first cell and the second cell can be different cells. Further, the first cell and the second cell can be the same cell.

FIG. 5 is a schematic block diagram showing a timer control device according to another embodiment of the present disclosure. As shown in FIG. 5, apart from those components described with respect to the embodiment shown in FIG. 4, the timer control device can also include a first determination module 3 that is configured to determine whether the user device is configured with a bandwidth part inactivity timer, before the message receiver 1 receives at the first cell the message of the physical downlink control channel sent by the base station. The timer controller 2 is configured to start or restart the bandwidth part inactivity timer for the activated downlink bandwidth part of the first cell, and to start or restart the bandwidth part inactivity timer for the activated downlink bandwidth part of the second cell, if the user device is configured with a bandwidth part inactivity timer, and it is determined based on the message of the physical downlink control channel that the random access initiated by the second cell to the base station is successful. Of course, it should be understood that one or more of the modules described in this disclosure can be implemented by circuitry.

FIG. 6 is a schematic block diagram showing a timer control device according to yet another embodiment of the present disclosure. As shown in FIG. 6, apart from those components described with respect to the embodiment shown in FIG. 4, the timer control device can also include a second determination module 4 that is configured to determine whether the first cell and the second cell are configured with a bandwidth part inactivity timer, before the message receiver 1 receives at the first cell the message of the physical downlink control channel sent by the base station. The timer controller 2 can be configured to start or restart the bandwidth part inactivity timer for the activated downlink bandwidth part of is the first cell, and to start or restart the bandwidth part inactivity timer for the activated downlink bandwidth part of the second cell, if the first cell and the second cell are configured with a bandwidth part inactivity timer, and the random access initiated by the second cell to the base station is successful as determined based on the message of the physical downlink control channel. With respect to the timer control device in the above-mentioned embodiments, the specific manner in which each module thereof performs its operation has been described in detail in the embodiments of the relevant timer control method, and will not be described herein in detail.

As embodiments of the timer control device correspond essentially to the embodiments of the timer control method, it is sufficient to refer to the repeated description with respect to the respective embodiments of the timer control method. The above described embodiments with respect to the timer control device are merely illustrative, wherein the units illustrated as separate parts may or may not be physically separated, and the parts shown as units may or may not be physical units, i.e. may be located in one place, or may also be distributed over a plurality of network units. Some or all of the modules may be selected according to actual needs, so as to achieve the purpose of the example embodiment. This will be understood and implemented by those of ordinary skill in the art without any creative work.

Embodiments of the present disclosure also provide an electronic apparatus having a processor and a memory that is configured to store instructions executable by the processor. The processor can be configured to perform the timer control method described in any of the above embodiments.

Alternative embodiments of the present disclosure also provide a computer readable storage medium on which a computer program is stored, wherein the computer program is configured, when executed by the processor, to implement steps of the timer control method described in any of the above embodiments.

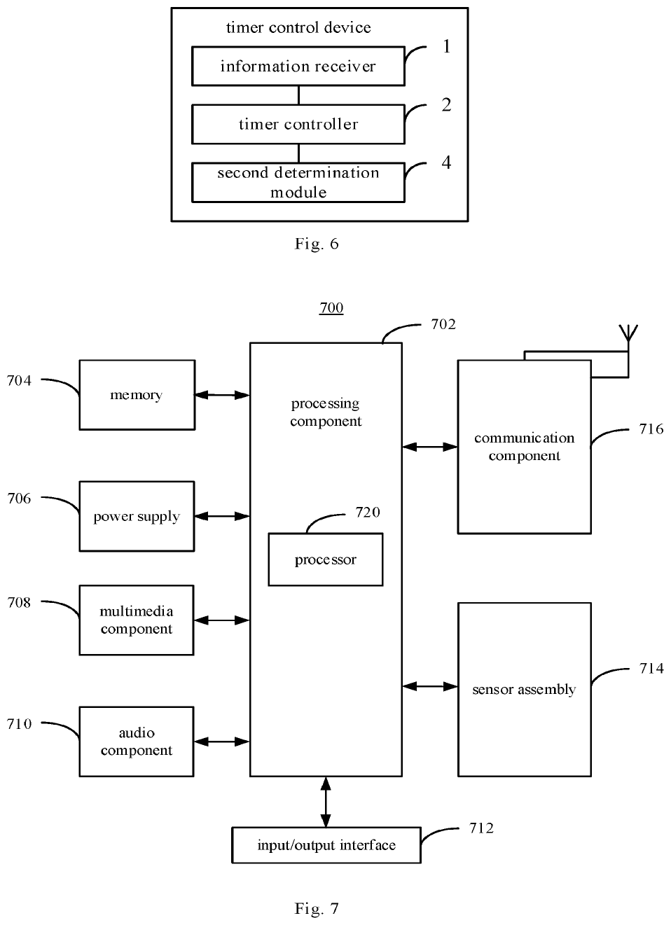

FIG. 7 is a schematic block diagram showing an apparatus 700 for controlling a timer according to an embodiment of the present disclosure. For example, the apparatus 700 can be a mobile phone, a computer, a digital radio terminal, a message transceiver, a gaming console, a tablet device, a medical device, a fitness device, a personal digital assistant, and the like.

Referring to FIG. 7, the apparatus 700 can include one or more of the following components: a processing component 702, a memory 704, a power supply 706, a multimedia component 708, an audio component 710, an input/output (I/O) interface 712, a sensor assembly 714, and a communication component 716.

The processing component 702 typically controls the overall operation of the apparatus 700, such as those associated with display, telephone calling, data communication, camera operation, and recording operation. The processing component 702 can comprise one or more processors 720 to execute instructions, so as to implement all or some of the steps of the timer control method described above. Additionally, the processing component 702 can comprise one or more modules to facilitate interactions between the processing component 702 and other components. For example, the processing component 702 can include a multimedia module to facilitate interactions between the multimedia component 708 and the processing component 702.

The memory 704 is configured to store various types of data to support operations on the apparatus 700. Examples of such data comprise instructions for any application or method used to operate on the apparatus 700, contact data, phonebook data, messages, pictures, videos, and the like. Memory 704 can be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, Disk or CD.

The power supply 706 provides power to various components of the apparatus 700. The power supply 706 can includes a power management system, one or more power sources, and other components associated with the generation, management, and distribution of power for the apparatus 700.

The multimedia component 708 can include a screen providing an output interface between the apparatus 700 and the user. In some embodiments, the screen can include a liquid crystal display (LCD) and a touch panel (TP). If the screen includes a touch panel, the screen can be implemented as a touch screen to receive an input signal from the user. The touch panel includes one or more touch sensors to sense touch, slide, and gestures on the panel. The touch sensors can not only sense a boundary of the touch or slide operation, but also detect a time duration and pressure associated with the touch or slide operation. In some embodiments, the multimedia component 708 includes a front camera and/or a rear camera. When the apparatus 700 is in an operating mode, such as a shooting mode or video mode, the front camera and/or the rear camera can receive external multimedia data. Each of the front camera and the rear camera can be a fixed optical lens system or have a focal length and optical zoom capability.

The audio component 710 is configured to output and/or input an audio signal. For example, the audio component 710 includes a microphone (MIC) that is configured to receive an external audio signal when the apparatus 700 is in an operating mode, such as a calling mode, a recording mode, and a voice recognition mode. The received audio signal can be further stored in the memory 704 or sent via the communication component 716. In some embodiments, the audio component 710 can also include a speaker for outputting the audio signal.

The I/O interface 712 provides an interface between the processing component 702 and a peripheral interface module, which peripheral interface module may be a keyboard, a click wheel, buttons, and the like. These buttons can include, but are not limited to, a home button, a volume button, a start button, and a lock button.

The sensor assembly 714 can include one or more sensors for providing a status assessment of various aspects of the apparatus 700. For example, the sensor assembly 714 can detect an on/off state of the apparatus 700, and the relative positioning of components, such as display and keypad of the apparatus 700. The sensor assembly 714 can also detect a change in the position of the apparatus 700 or of a component in the apparatus 700, the presence or absence of a user contact with the apparatus 700, the orientation or acceleration/deceleration of the apparatus 700, and a change in the temperature of the apparatus 700. The sensor assembly 714 can include a proximity sensor, configured to detect the presence of nearby objects in the absence of any physical contact. The sensor assembly 714 can also comprise an optical sensor, such as a CMOS or CCD image sensor, for use in an imaging application. In some embodiments, the sensor assembly 714 can also comprise an acceleration sensor, a gyroscope sensor, a magnetic sensor, a pressure sensor, or a temperature sensor.

The communication component 716 is configured to facilitate a wired or wireless communication between the apparatus 700 and other devices. The apparatus 700 can have access to a wireless network based on any communication standard, such as Wi-Fi, 2G or 3G, or a combination thereof In an exemplary embodiment, the communication component 716 receives broadcast signals or broadcast-related information from an external broadcast management system via a broadcast channel. In an exemplary embodiment, the communication component 716 also comprises a near-field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology, and other technologies.

In exemplary embodiments, the apparatus 700 can be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for performing the method described in any of the above embodiments.

In exemplary embodiments, there is also provided a non-transitory computer readable storage medium containing instructions, such as a memory 704 containing instructions, which instructions can be executed by a processor 720 of the apparatus 700 so as to implement the timer control method described above. For example, the non-transitory computer readable storage medium can be ROM, random access memory (RAM), CD-ROM, magnetic tape, floppy disks, and optical data storage devices, among others.

Those of skill in the art will readily think of other implementations of the present disclosure after considering the present specification and practicing the present disclosure described herein into practice. The present application is intended to cover any variations, uses, or adaptations of the present disclosure that follow the general principle of the present disclosure, and encompass the common knowledge or customary technical means in the art that are not disclosed herein. Descriptions and examples are considered to be exemplary only, and the true scope and spirit of the present disclosure is indicated by the following claims.

It is to be understood that the present disclosure is not limited to the precise structure already described above and shown in the accompanying drawings, and that various modifications and changes can be made without departing from the scope of the present disclosure. The scope of the present disclosure is limited only by the appended claims.

It should be noted that, in the present description, relational terms such as first and second are used only to distinguish one entity or operation from another, and do not necessarily require or imply any such relationship or sequence between them. The term “comprise”, “contain”, or any other variation thereof is intended to cover a non-exclusive inclusion, such that a process, method, article or device comprising a set of elements comprises not only those elements but also other elements that are not explicitly listed. Alternatively, an element inherent to such process, method, article, or device may also be comprised. Without any further limitation, the element accompanied by the expression of “comprise a . . . ” does not preclude the presence of a further identical element in the process, method, article, or device that comprises such element.

The method and device provided by embodiments of the present invention is have been described in detail above, and specific examples have been used in the present description to illustrate the principle and implementation of the present invention. All the above description of the embodiments is only used to help understanding the timer control method of the present invention and its essential ideas. At the same time, for those of ordinary skill in the art, according to the idea of the present invention, there will be changes in the specific implementations and applications. In summary, the above content of the present specification should not be construed as a limitation to the present invention.

1. A timer control method that is applicable to a user device, the timer control method comprising:
receiving a message of a physical downlink control channel at a first cell that is sent by a base station;
starting or restarting a bandwidth part inactivity timer for an activated downlink bandwidth part of the first cell; and
starting or restarting a bandwidth part inactivity timer for an activated downlink bandwidth part of a second cell when the message of the physical downlink control channel indicates that a random access initiated at the second cell to the base station is successful.

2. The timer control method according to claim 1, wherein the first cell and the second cell are different cells.

3. The timer control method according to claim 1, wherein the first cell and the second cell are a same cell.

4. The timer control method according to claim 1, further comprising:
determining whether the user device is configured with the bandwidth part inactivity timer before the message of the physical downlink control channel sent by the base station is received at the first cell,
wherein the bandwidth part inactivity timer for the activated downlink bandwidth part of the first cell is started or restarted when the user device is configured with a bandwidth part inactivity timer, and
the bandwidth part inactivity timer for the activated downlink bandwidth part of the second cell is started or restarted when the message of the physical downlink control channel indicates that the random access initiated at the second cell to the base station is successful.

5. The timer control method according to claim 1, further comprising:
determining whether the first cell and the second cell are configured with the bandwidth part inactivity timer, before the message of the physical downlink control channel is sent by the base station is received at the first cell,
wherein:
the bandwidth part inactivity timer for the activated downlink bandwidth part of the first cell is started or restarted when the first cell and the second cell are configured with the bandwidth part inactivity timer, and
the bandwidth part inactivity timer for the activated downlink bandwidth part of the second cell is started or restarted when the message of the physical downlink control channel indicates that the random access initiated at the second cell to the base station is successful.

6. A timer control device that is applicable to a user device, the timer control device comprising:
a message receiver that is configured to receive a message of a physical downlink control channel at a first cell that is sent by a base station; and
a timer controller that is configured to start or restart a bandwidth part inactivity timer for an activated downlink bandwidth part of the first cell, and to start or restart a bandwidth part inactivity timer for an activated downlink bandwidth part of a second cell when a message of the physical downlink control channel indicates that a random access initiated at the second cell to the base station is successful.

7. The timer control device according to claim 6, wherein the first cell and the second cell are different cells.

8. The timer control device according to claim 6, wherein the first cell and the second cell are a same cell.

9. The timer control device according to claim 6, further comprising:
a first determination module that is configured to determine whether the user device is configured with a bandwidth part inactivity timer before the message receiver receives at the first cell the message of the physical downlink control channel sent by the base station,
wherein the timer controller is configured to start or restart the bandwidth part inactivity timer for the activated downlink bandwidth part of the first cell, and to start or restart the bandwidth part inactivity timer for the activated downlink bandwidth part of the second cell when user device is configured with a bandwidth part inactivity timer, and the random access initiated at the second cell to the base station is successful as determined based on the message of the physical downlink control channel.

10. The timer control device according to claim 6, further comprising:
a second determination module that is configured to determine whether the first cell and the second cell are configured with a bandwidth part inactivity timer, before the message receiver receives at the first cell the message of the physical downlink control channel sent by the base station,
wherein the timer controller is configured to start or restart the bandwidth part inactivity timer for the activated downlink bandwidth part of the first cell, and to start or restart the bandwidth part inactivity timer for the activated downlink bandwidth part of the second cell when the first cell and the second cell are configured with a bandwidth part inactivity timer, and the random access initiated at the second cell to the base station is successful as determined based on the message of the physical downlink control channel.

11. An electronic apparatus
having a processor
and a memory that is configured to store instructions executable by the processor
the processor being configured to perform a timer control method comprising:
receiving a message of a physical downlink control channel at a first cell that is sent by a base station;
starting or restarting a bandwidth part inactivity timer for an activated downlink bandwidth part of the first cell; and
starting or restarting a bandwidth part inactivity timer for an activated downlink bandwidth part of a second cell when the message of the physical downlink control channel indicates that a random access initiated at the second cell to the base station is successful.

12. A computer readable storage medium, on which a computer program is stored that, when executed by a processor, causes the processor to implement steps of the timer control method according to claim 1.

13. The electronic apparatus according to claim 11, wherein the first cell and the second cell are different cells.

14. The electronic apparatus according to claim 11, wherein the first cell and the second cell are a same cell.

15. The electronic apparatus according to claim 11, wherein the timer control method further comprises:
determining whether the user device is configured with a bandwidth part inactivity timer before the message of the physical downlink control channel sent by the base station is received at the first cell,
wherein:
the bandwidth part inactivity timer for the activated downlink bandwidth part of the first cell is started or restarted when the user device is configured with a bandwidth part inactivity timer, and
the bandwidth part inactivity timer for the activated downlink bandwidth part of the second cell is started or restarted when the message of the physical downlink control channel indicates that the random access initiated at the second cell to the base station is successful.

16. The electronic apparatus according to claim 11, wherein the timer control method further comprises:
determining whether the first cell and the second cell are configured with a bandwidth part inactivity timer before the message of the physical downlink control channel sent by the base station is received at the first cell,
wherein:
the bandwidth part inactivity timer for the activated downlink bandwidth part of the first cell is started or restarted when the first cell and the second cell are configured with a bandwidth part inactivity timer, and
the bandwidth part inactivity timer for the activated downlink bandwidth part of the second cell is started or restarted when the message of the physical downlink control channel that the random access initiated at the second cell to the base station is successful.
